(19) United States
(12) Patent Application Publication
(10) Pub. No.: US 2026/0326685 A1
(43) Pub. Date: Oct. 22, 2026

(54) DECORATIVE SHEET AND MANUFACTURING METHOD THEREOF

(71) Applicant: TOKAI CHEMICAL INDUSTRIES, LTD., Gifu (JP)

(72) Inventors: Takemasa OKUMURA, Gifu (JP); Yosuke Naruse, Gifu (JP)

(73) Assignee: TOKAI CHEMICAL INDUSTRIES, LTD., Gifu (JP)

(21) Appl. No.: 19/693,585

(22) Filed: Jun. 1, 2026

Related U.S. Application Data
(63) Continuation of application No. PCT/JP2024/043300, filed on Dec. 6, 2024.

(30) Foreign Application Priority Data
Dec. 28, 2023 (JP) 2023-222813

(51) Int. Cl. B60R 13/02

(52) U.S. Cl. CPC B60R 13/0243

(57) ABSTRACT

The decorative sheet (1) includes: a skin layer (3) that is light-transmissive; an intermediate layer (4) arranged on a back side of the skin layer (3); and a design layer (5) having a design field (50) on which a predetermined design is drawn and arranged on a back side of the intermediate layer (4). The skin layer (3) has a display field (30) on which the design is displayed by light irradiated from a back side to the design field (50). The design field (50) is arranged gaplessly over an entire surface of the display field (30) when viewed from an outer side and has higher light transmittance than the intermediate layer (4).

### CROSS-REFERENCE TO RELATED APPLICATION

This application is a continuation of PCT International Application No. PCT/JP2024/043300, filed on Dec. 6 2024, which claims priority under 35 U.S. C § 119(a) to Japanese Patent Application No. 2023-222813, filed on Dec. 28, 2023. Each of the above applications is hereby expressly incorporated by reference, in its entirety, into the present application.

### BACKGROUND

### Technical Field

The disclosure relates to a decorative sheet used for, for example, an interior member of a vehicle, and a manufacturing method thereof.

### Description of Related Art

In the field of the interior of vehicles, the development of decorative sheets capable of switching designs visible from inside the vehicle compartment by turning on and off the backlight is advancing. For example, Patent Document 1 discloses a display device including a surface protection layer, a pattern layer and a void part, a base material, a dimming sheet, a light-emitting display body (display), and a display control device. The surface protection layer, the pattern layer and the void part, the base material, the dimming sheet, and the light-emitting display body are stacked in this order from the outer side (vehicle compartment interior side) toward the back side. The display control device is arranged separately from the members.

The surface protection layer is colorless and transparent. A pattern such as a wood grain vessel pattern or a marble pattern is printed on the pattern layer. The pattern layer is printed on the base material surface. The void part is juxtaposed with the pattern layer. The void part corresponds to the portion of the base material surface where the pattern layer is not printed.

The display control device can adjust the light transmittance of the dimming sheet in response to turning on and off of the light-emitting display body. Specifically, the display control device can adjust the light transmittance of the dimming sheet, so as to transmit light when the light-emitting display body is turned on and not to transmit light when the light-emitting display body is turned off.

### PRIOR ART DOCUMENT(S)

### Patent Document(s)

Patent Document 1: Japanese Patent Application Publication Laid-open No. 2021-162723

In the case of the display device of the same document, a dimming sheet is required. Also, adjustment of the light transmittance of the dimming sheet by the display control device is required. For this reason, the layer configuration and electrical configuration become complicated. Also, in the case of the display device of the same document, when the light-emitting display body is on, the pattern layer and the void part juxtaposed with each other cooperate to display a desired design on the surface of the surface protection layer.

Here, the pattern layer and the void part are stacked directly behind the surface protection layer without mediating other layers. Also, the pattern layer has low light transmittance, and the void part has high light transmittance. For this reason, the contrast stands out, and the boundary between the pattern layer and the void part tends to become distinct. Therefore, when the light-emitting display body is OFF, there is a possibility that the pattern layer and the void part may be visible through the surface of the surface protection layer.

Therefore, the disclosure aims to provide a decorative sheet and a manufacturing method thereof that have simple layer configuration and electrical configuration, and can suppress the design field of the design layer from being visible through the surface of the skin layer when the backlight is OFF.

### SUMMARY

An aspect of the disclosure provides a decorative sheet. The decorative sheet includes: a skin layer, being light-transmissive; an intermediate layer, arranged on a back side of the skin layer; a design layer, arranged on a back side of the intermediate layer and having a design field on which a predetermined design is drawn. The skin layer has a display field on which the design is displayed by light irradiated from a back side to the design field. The design field is arranged gaplessly over an entire surface of the display field when viewed from an outer side, and has higher light transmittance than the intermediate layer.

Another aspect of the disclosure provides a manufacturing method of a decorative sheet. The decorative sheet includes: a skin layer, being light-transmissive; an intermediate layer, arranged on a back side of the skin layer; a design layer, arranged on a back side of the intermediate layer and having a design field on which a predetermined design is drawn. The skin layer has a display field on which the design is displayed by light irradiated from a back side to the design field. The design field is arranged gaplessly over an entire surface of the display field when viewed from an outer side, and has higher light transmittance than the intermediate layer. The manufacturing method includes: an intermediate layer printing step of printing the intermediate layer on a back surface of the skin layer; and a design layer printing step of printing the design layer on a back surface of the intermediate layer.

### BRIEF DESCRIPTION OF THE DRAWINGS

FIG. 1 is a partial perspective view of a door trim on which a decorative sheet of a first embodiment is arranged.

FIG. 2 is a perspective view inside a frame II of FIG. 1.

FIG. 3 is an exploded perspective view inside the frame II of FIG. 1.

FIG. 4 is a cross-sectional view in a IV-IV direction of FIG. 2.

FIG. 5 is a partial cross-sectional view of a decorative sheet of a second embodiment in an outer-back direction.

FIG. 6 is a partial cross-sectional view of a decorative sheet of a third embodiment in an outer-back direction.

### DESCRIPTION OF THE EMBODIMENTS

(1) To solve the above issues, a decorative sheet of the disclosure is provided. The decorative sheet includes: a skin layer that is light-transmissive; an intermediate layer, arranged on a back side of the skin layer; and a design layer, arranged on a back side of the intermediate layer and having a design field on which a predetermined design is drawn. The skin layer has a display field on which the design is displayed by light irradiated from the back side to the design field, and the design field is arranged gaplessly over an entire surface of the display field when viewed from an outer side, and has higher light transmittance than the intermediate layer.

With the configuration, a member for adjusting the light transmittance of a layer (e.g., the display control device and the dimming sheet of Patent Document 1) is not required. For this reason, layer configuration and electrical configuration are simple. Also, the design field of the design layer is arranged gaplessly over the entire surface of the display field when viewed from the outer side. For this reason, the boundary itself between the design portion and the gap is not present in the design field. Therefore, it is possible to suppress the design field of the design layer from being visible through the surface of the skin layer when the backlight is turned off.

If it is assumed that a case where the design layer has lower light transmittance than the intermediate layer, in this case, the intermediate layer becomes more likely to transmit light than the design layer. For this reason, when the backlight is turned off, light tends to transmit through the intermediate layer, and the design field of the design layer tends to be visible through the surface of the skin layer.

In this regard, according to the configuration, the design layer has higher light transmittance than the intermediate layer. For this reason, the intermediate layer is less likely to transmit light than the design layer. Therefore, it is possible to suppress the design field of the design layer from being visible through the intermediate layer on the surface of the skin layer when the backlight is turned off.

(1-1) In the configuration of (1), the skin layer may have an uneven part on a surface thereof. According to this configuration, when the backlight is turned off, light from outside can be diffusely reflected between the concave and convex portions of the uneven part. For this reason, a boundary part of the design field of the design layer (as an example, when the design field of the design layer has a wood grain pattern, a portion where the shade of the wood grain stands out, etc.,) can be blurred. Therefore, it is possible to suppress the boundary part of the design field from being visible through the surface of the skin layer.

(1-2) In the configuration of (1), the design layer is preferably a printed layer on which a predetermined pattern is formed by printing. According to this configuration, compared to the case where the design layer is a coating film or the like, for example, the variation in the layer thickness of the design layer can be suppressed. Also, the layer thickness of the design layer can be suppressed from becoming excessively large.

(2) In the configuration of the above (1), the visible light transmittance rate of the intermediate layer may be 3% or more and 50% or less. In the disclosure, “visible light” refers to electromagnetic waves in a wavelength range perceived as light by the human eye. The wavelength range of visible light is, for example, 360 nm or more and 830 nm or less. Also, “visible light transmittance rate” τ refers to a ratio at which visible light passes through a sample (for example, the intermediate layer, the design layer, etc.) With the luminosity of incident light being I₀ and the luminosity of light that has passed through the sample being I, the visible light transmittance rate is expressed as τ(%)=(I/I₀)×100. According to this configuration, compared to the case where the visible light transmittance rate is less than 3%, the visibility of the design in the design field when the backlight is on can be improved. Also, compared to the case where the visible light transmittance rate exceeds 50%, it is possible to suppress the design of the design field from being visible through the surface of the skin layer when the backlight is turned off.

(3) In the configuration of the above (1), the visible light transmittance rate of the design field may be 5% or more and 90% or less. According to this configuration, compared to the case where the visible light transmittance rate is less than 5%, it is possible to suppress the design of the design field from being visible through the surface of the skin layer when the backlight is OFF. Also, compared to the case where the visible light transmittance rate exceeds 90%, the visibility of the design in the design field when the backlight is ON can be improved.

(4) In the configuration of the above (1), a configuration may be provided to be arranged on an interior member of a vehicle. According to this configuration, by switching the backlight on and off, the design of the interior member can have duality.

(5) In order to solve the above issues, a manufacturing method of a decorative sheet of the disclosure is provided. The decorative sheet includes: a skin layer that is light-transmissive; an intermediate layer arranged on a back side of the skin layer; and a design layer arranged on a back side of the intermediate layer and having a design field on which a predetermined design is drawn. The skin layer has a display field on which the design is displayed by light irradiated from the back side to the design field. The design field is arranged gaplessly over an entire surface of the display field when viewed from an outer side and has higher light transmittance than the intermediate layer. The manufacturing method includes: an intermediate layer printing step of printing the intermediate layer on a back surface of the skin layer; and a design layer printing step of printing the design layer on a back surface of the intermediate layer.

With the configuration, compared to the case where the intermediate layer is a coating film or the like, for example, variation in the layer thickness of the intermediate layer can be suppressed. Also, the layer thickness of the intermediate layer can be suppressed from becoming excessively large. The design layer also has the same effect as the intermediate layer. Also, positional deviation in the edgewise direction (layer development direction; a direction intersecting the stacking direction) among the three layers (skin layer, intermediate layer, design layer) can be suppressed.

According to the decorative sheet and the manufacturing method thereof of the disclosure, the layer configuration and the electrical configuration become simple. Also, when the backlight is OFF, it is possible to suppress the design field of the design layer from being visible through the surface of the skin layer.

Hereinafter, embodiments of a decorative sheet and a manufacturing method thereof of the disclosure are described.

### First Embodiment

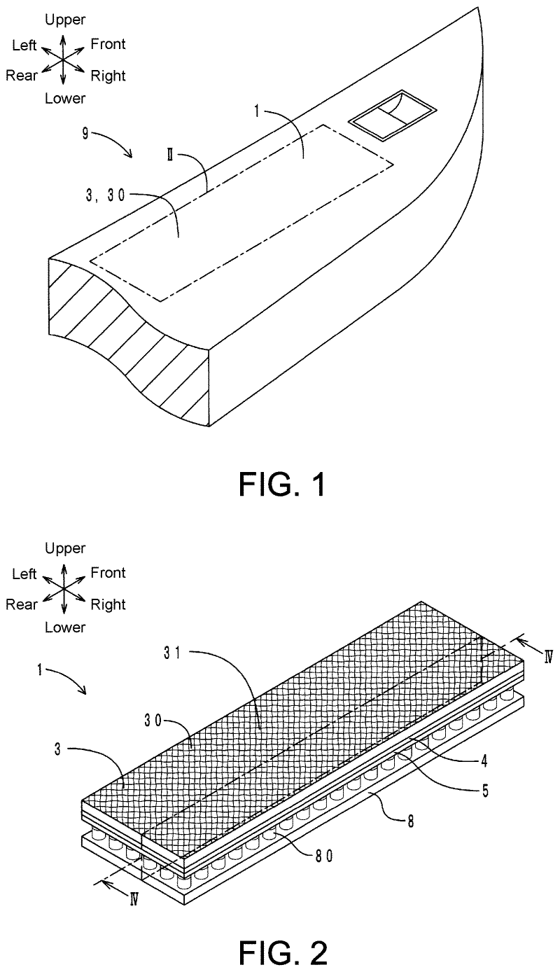

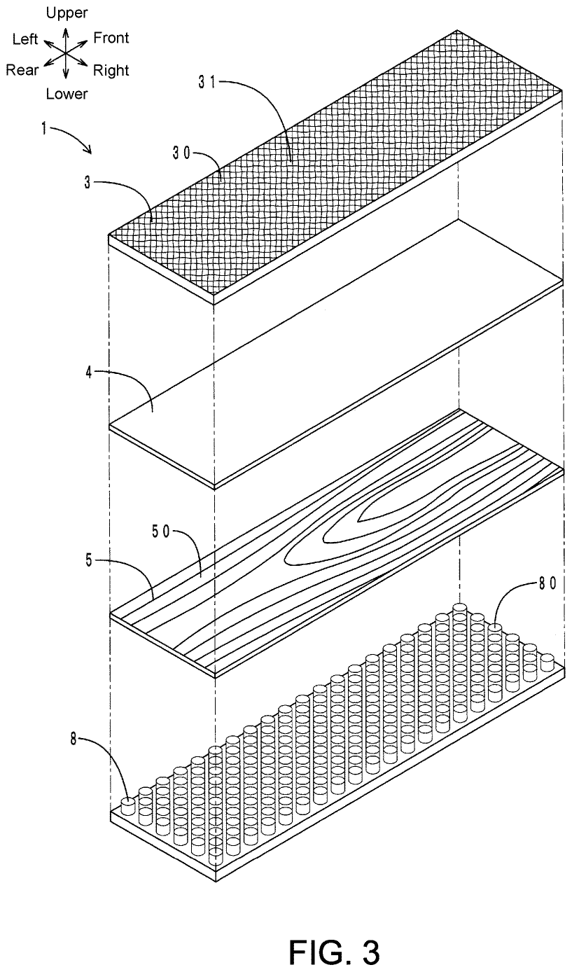

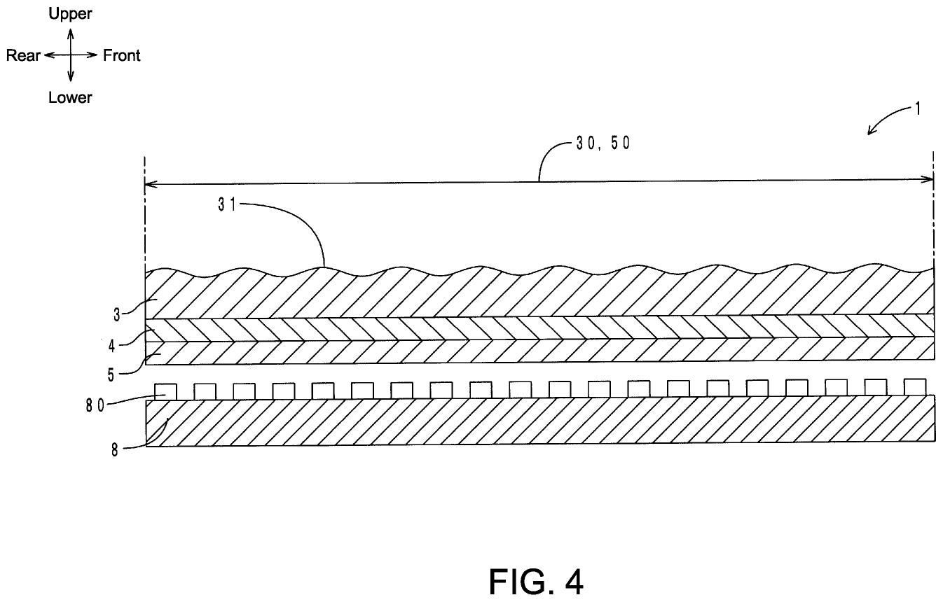

FIG. 1 shows a partial perspective view of a door trim in which a decorative sheet of the embodiment is arranged. FIG. 2 shows a perspective view inside a frame II of FIG. 1. FIG. 3 shows an exploded perspective view inside the frame II of FIG. 1. FIG. 4 shows a cross-sectional view in an IV-IV direction (cross-sectional view in the outer-back direction) of FIG. 2.

### (Arrangement and Configuration of Decorative Sheet)

First, the arrangement and configuration of the decorative sheet of the embodiment are described. As shown in FIG. 1, a decorative sheet 1 is arranged on a door trim 9 of the vehicle compartment. The door trim 9 is included in the concept of “interior member” of the disclosure. As shown in FIG. 1 to FIG. 4, the door trim 9 includes the decorative sheet 1 and a light source part 8. The decorative sheet 1 and the light source part 8 are laminated in this order from the outer side (upper side, vehicle compartment interior side) toward the back side (lower side, vehicle compartment exterior side).

As shown in FIG. 3 to FIG. 4, the decorative sheet 1 includes, from the outer side toward the back side, a skin layer 3, an intermediate layer 4, and a design layer 5. As shown in FIG. 1, the surface (upper surface) of the skin layer 3 is exposed to the vehicle compartment. The skin layer 3 is made of synthetic leather and presents a layered form. The skin layer 3 is light-transmissive and flexible. The skin layer 3 includes a display field 30 and a texture part (uneven part) 31 on the surface. A texture part 31 is arranged over the entire surface of the skin layer 3. Light is irradiated from the light source part 8 on the back side to the design field 50 described later. With the light, the wood grain pattern of the design field 50 is displayed on the display field 30.

The intermediate layer 4 is arranged on the back side of the skin layer 3. The intermediate layer 4 is made of light-transmissive ink and presents a layered form. The intermediate layer 4 has light transmittance and flexibility. The intermediate layer 4 has lower light transmittance than the skin layer 3. The intermediate layer 4 is smoke-toned to be translucent. The intermediate layer 4 is colored transparent.

The design layer 5 is arranged on the back side of the intermediate layer 4. The design layer 5 is made of light-transmissive ink and presents a layered form. The design layer 5 is light-transmissive and flexible. The design layer 5 has higher light transmittance than the intermediate layer 4. The design layer 5 is colored transparent. The design layer 5 has the design field 50 on which a wood grain pattern is displayed when viewed from the outer side. The wood grain pattern is included in the concept of “predetermined design” of the disclosure. When viewed from the outer side, the design field 50, the display field 30, and the light source part 8 overlap. When viewed from the outer side, the design field 50 is arranged gaplessly over the entire surface of the display field 30.

The light source part 8 is arranged on the back side of the design layer 5 of the decorative sheet 1. The light source part 8 includes multiple light sources (e.g., LEDs) 80. The light sources 80 are distributed throughout the edgewise direction (layer development direction; direction intersecting the lamination direction; planar direction) of the light source part 8. The surface of the light source part 8 can emit light over the entire surface. The light from the light sources 80 reaches the surface of the door trim 9 via the design layer 5, the intermediate layer 4, and the skin layer 3.

### (Function of Decorative Sheet)

Next, the function of the decorative sheet of the embodiment will be described. In the case where the light source part 8 is turned off, the light sources 80 are turned off. That is, the backlight for the decorative sheet 1 is in an OFF state. Here, the light transmittance of each layer is set such that, in order from highest, the skin layer 3 (most easily transmits light), the design layer 5, and the intermediate layer 4 (least easily transmits light). Therefore, it is difficult for a user to visually recognize the design field 50 of the design layer 5 from the outer side (vehicle compartment interior) of the decorative sheet 1. Also, it is easy for a user to visually recognize the three-dimensional shape of the texture part 31 of the display field 30 of the skin layer 3 and the color of the intermediate layer 4 from the outer side (vehicle compartment interior) of the decorative sheet 1 integrally.

In the case where the light source part 8 is ON, the light sources 80 are turned on. That is, the backlight for the decorative sheet 1 is in an ON state. Since light first passes through the design layer 5 nearest to the light source part 8, the light of the light source part 8 preferentially displays the color scheme of the design field 50 (that is, the wood grain pattern), it is easy for a user to visually recognize the wood grain pattern. In this way, the decorative sheet 1 can display two types of designs in the display field 30 in response to ON and OFF of the light source part 8.

### (Manufacturing Method of Decorative Sheet)

Next, the manufacturing method of the decorative sheet of the embodiment will be described. The manufacturing method of the decorative sheet 1 includes an intermediate layer printing process and a design layer printing process. The manufacturing method is executed in a state where the decorative sheet 1 shown in FIG. 1 to FIG. 4 is set upside down. In the intermediate layer printing process, the intermediate layer 4 is printed on the back surface (upper surface) of the skin layer 3 with the texture part 31 by a silk screen printer. In the case where the intermediate layer 4 has a multi-layer structure (for example, a structure having a surface layer (transparent layer) and a back layer (colored layer)), the respective layers are printed in order. In the design layer printing process, the design layer 5 is printed on the back surface (upper surface) of the intermediate layer 4 by a silk screen printer. In the case where the design layer 5 has a multi-layer structure (for example, a structure that forms a wood grain pattern when viewed from the outer side by laminating multiple layers), the respective layers are printed in order.

### (Operational Effect)

Next, the operational effect of the decorative sheet and the manufacturing method thereof of the embodiment will be described. According to the decorative sheet 1 of the embodiment, a member for adjusting the light transmittance of the intermediate layer 4 and the design layer 5 (for example, the display control device and the dimming sheet of Patent Document 1) is unnecessary. For this reason, the layer configuration and the electrical configuration are simple. In addition, the design field 50 of the design layer 5 is arranged gaplessly over the entire surface of the display field 30 when viewed from the outer side. For this reason, a boundary itself between a design portion (wood grain pattern portion) and a gap is absent in the design field 50. Therefore, it is possible to suppress the design field 50 of the design layer 5 from being visible on the surface of the skin layer 3 when the backlight (light source part 8) is turned off.

It is assumed that the design layer 5 has lower light transmittance than the intermediate layer 4. In such case, it is more likely to transmit through the intermediate layer 4 than the design layer 5. For this reason, when the backlight is turned off, light transmits through the intermediate layer 4, and the design field 50 of the design layer 5 (that is, the wood grain pattern) is likely to be visible on the surface of the skin layer 3.

In this regard, according to the decorative sheet 1 of the embodiment, the design layer 5 has higher light transmittance than the intermediate layer 4. For this reason, the intermediate layer 4 is less likely to transmit than the design layer 5. Therefore, it is possible to suppress the design field 50 of the design layer 5 from being visible through the intermediate layer 4 on the surface of the skin layer 3 when the backlight is turned off.

The skin layer 3 has the texture part 31 on the surface. For this reason, when the backlight is turned off, the light from the outside can be diffusely reflected between the concave and convex portions of the texture part 31. Therefore, the boundary part of the design field 50 of the design layer 5 (a portion where the shade of the wood grain of the wood grain pattern of the design field 50 stands out) can be blurred. Thus, it is possible to suppress the boundary part of the design field 50 from being visible on the surface of the skin layer 3. The skin layer 3 is colorless and transparent, and has higher light transmittance than the design layer 5 and the intermediate layer 4. For this reason, the texture part 31 becomes apparent mainly when the light is turned off.

The design layer 5 is a printed layer on which a wood grain pattern is formed by printing. For this reason, compared to the case where the design layer 5 is a coating film or the like, variation in the layer thickness (thickness in the outer-back direction) of the design layer 5 can be suppressed. In addition, the layer thickness of the design layer 5 can be suppressed from becoming excessively large.

The visible light transmittance rate of the intermediate layer 4 is 8%. That is, the visible light transmittance rate of the intermediate layer 4 falls in a range of 3% or more and 50% or less. For this reason, compared to the case where the visible light transmittance rate is less than 3%, the visibility of the wood grain pattern of the design field 50 when the backlight is turned on can be improved. In addition, compared to the case where the visible light transmittance rate exceeds 50%, the visibility of the wood grain pattern of the design field 50 when the backlight is turned off can be reduced. Hereinafter, a measurement method of the visible light transmittance rate is described. First, in a dark room without lighting, a sample is set on an LED light source (luminance 3000 cd/m²), and the LED light source is turned on. Next, at a position 1000 mm away from the measurement point of the sample (a circular portion with a diameter of approximately 4 mm), the luminosity I0 of incident light and the luminosity I of light that has passed through the sample are measured using a color luminance meter (manufactured by Konica Minolta, Inc., model number CS-160). Thereafter, from the measurement results, the visible light transmittance rate is calculated using the formula: visible light transmittance rate τ(%)=(I/I0)×100.

The visible light transmittance rate of the design field 50 (measured by the measurement method described above) is 55%. That is, the visible light transmittance rate of the design field 50 is included in a range of 5% or more and 90% or less. For this reason, compared to the case where the visible light transmittance rate is less than 5%, it is possible to suppress the design of the design field 50 from being visible on the surface of the skin layer 3 when the backlight is turned off. In addition, compared to the case where the visible light transmittance rate exceeds 90%, the visibility of the design of the design field 50 when the backlight is turned off can be improved.

The decorative sheet 1 is arranged on the door trim 9. For this reason, by switching the backlight on and off, the design and texture of the door trim 9 can be provided with duality. Specifically, a leather-like design can be displayed on the door trim 9 when the light source part 8 is OFF, and a wood grain-like design can be displayed on the door trim 9 when the light source part 8 is ON.

The manufacturing method of the decorative sheet 1 includes the intermediate layer printing process and the design layer printing process. For this reason, compared to the case where the intermediate layer 4 is a coating film or the like, for example, variation in the layer thickness of the intermediate layer 4 can be suppressed. In addition, the layer thickness of the intermediate layer 4 can be suppressed from becoming excessively large. The design layer 5 also has the same effect as the intermediate layer 4. In addition, positional deviation in the edgewise direction among the three layers (the skin layer 3, the intermediate layer 4, and the design layer 5) can be suppressed.

### Second Embodiment

The difference between the decorative sheet and the manufacturing method thereof of the embodiment and the decorative sheet and the manufacturing method thereof of the first embodiment is that a flexible layer is additionally arranged. Here, only the difference will be described.

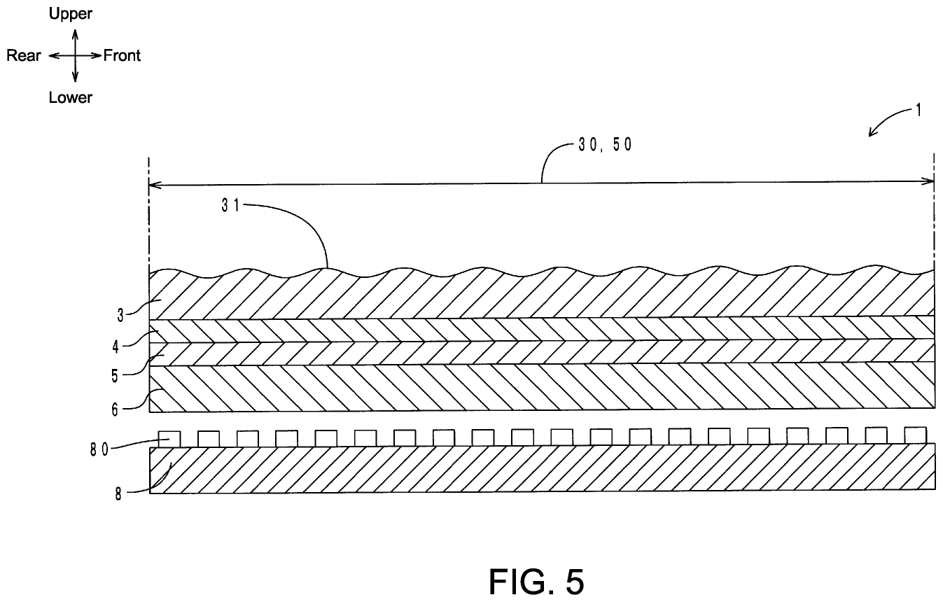

FIG. 5 shows a partial cross-sectional view of the decorative sheet of the embodiment in the outer-back direction. Parts corresponding to those in FIG. 4 are indicated by the same reference numerals. As shown in FIG. 5, a flexible layer 6 is interposed between the design layer 5 and the light source part 8. The flexible layer 6 is arranged on the back side of the design layer 5. The flexible layer 6 is made of thermoplastic elastomer and is flexible, light-transmissive, and light-diffusive. Light from the light source 80 is diffused by the flexible layer 6 in the edgewise direction. For this reason, the surface of the flexible layer 6 emits light over the entire surface.

The decorative sheet and the manufacturing method thereof of the embodiment have the same operational effect as the decorative sheet and the manufacturing method thereof of the first embodiment with respect to parts having a common configuration. The decorative sheet 1 of the embodiment includes the flexible layer 6. For this reason, flexibility can be ensured when a user touches the door trim 9 (see FIG. 1). In addition, light from the light source 80 can be diffused in the edgewise direction. For this reason, when viewed from the outer side, the light source part 8 can emit light uniformly over the entire surface.

### Third Embodiment

The difference between the decorative sheet and the manufacturing method thereof of the embodiment and the decorative sheet and the manufacturing method thereof of the second embodiment is that a base layer is additionally arranged. Here, only the difference will be described.

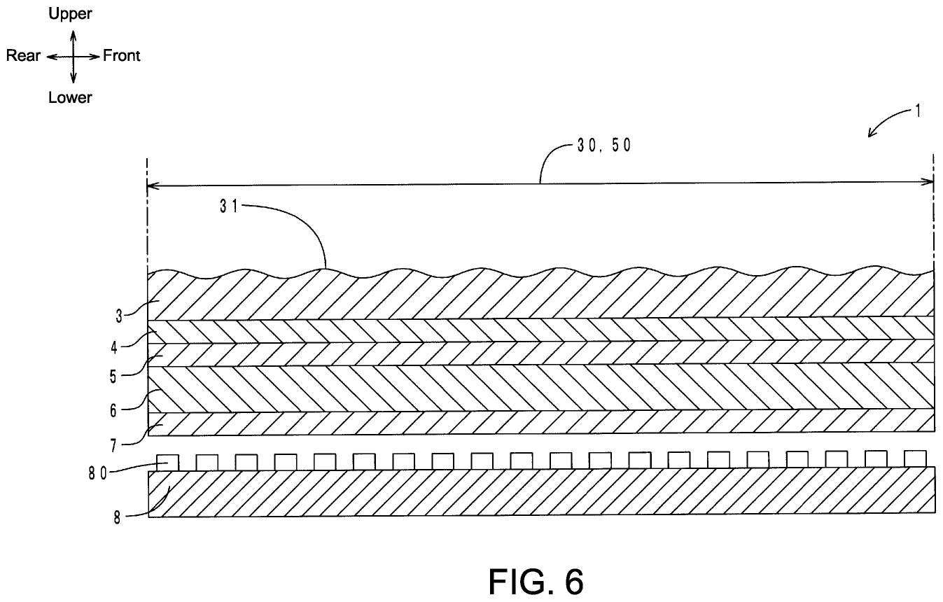

FIG. 6 shows a partial cross-sectional view of the decorative sheet of the embodiment in the outer-back direction. Parts corresponding to those in FIG. 5 are indicated by the same reference numerals. As shown in FIG. 6, a base layer 7 is interposed between the flexible layer 6 and the light source part 8. The base layer 7 is arranged on the back side of the flexible layer 6. The base layer 7 is made of resin and is light-transmissive and flexible.

The decorative sheet and the manufacturing method thereof of the embodiment have the same operational effect as the decorative sheet and the manufacturing method thereof of the second embodiment with respect to parts having a common configuration. The decorative sheet 1 of the embodiment includes the base layer 7. The base layer 7 is harder than other layers (the skin layer 3, the intermediate layer 4, the design layer 5, the flexible layer 6). For this reason, the shape retention property of the decorative sheet 1 can be ensured.

### Others

The embodiments of the decorative sheet and the manufacturing method thereof of the disclosure have been described above. However, the embodiments are not particularly limited to the above forms. It is also possible to implement in various modified forms and improved forms that can be made by those skilled in the art.

### (Regarding the Configuration)

The configuration of the field other than the design field 50 of the design layer 5 is not particularly limited. The field other than the design field 50 may be arranged gaplessly over the entire surface of the field other than the display field 30 when viewed from the outer side. Also, voids (void parts, recessed parts, etc.,) may be arranged in the field other than the design field 50.

The arrangement quantity, position, size, shape, etc., of the display field 30 and the design field 50 are not particularly limited. The layer structure of each layer (the skin layer 3, the intermediate layer 4, the design layer 5, the flexible layer 6, the base layer 7) is not particularly limited. It may be a single-layer structure or a multi-layer structure. Among the respective layers, another layer may be interposed between two layers adjacent in the outer-back direction (except the case of a layer between the flexible layer 6 and the base layer 7). Also, another layer may be arranged on the outer side of the skin layer 3.

The difference in area among the respective layers when viewed from the outer side is not particularly limited. For example, when viewed from the outer side, the intermediate layer 4 and the design layer 5 may be arranged on a portion of the skin layer 3. Also, when viewed from the outer side, the design layer 5 may be arranged on a portion of the intermediate layer 4. Also, when viewed from the outer side, the intermediate layer 4 may be arranged on a portion of the design layer 5.

The position and arrangement quantity of the light source 80 in the light source part 8 are not particularly limited. Also, a single light source 80 may include multiple LEDs. In this case, the colors of the LEDs may be different from each other. For example, in the case where one single light source 80 includes LEDs of three colors of red, green, and blue, white light can be irradiated in addition to red, green, and blue.

The design of the design field 50 of the design layer 5 is not particularly limited. A design may be different from the design (color, etc.,) of the intermediate layer 4. In this way, it is easy to provide duality to the design displayed in the display field 30 in response to the backlight being turned on and off.

As the design of the design field 50, for example, designs including one or more selected from patterns (wood grain pattern, marble pattern, stone wall pattern, polka dot pattern, striped pattern, lattice pattern, etc.), characters (alphabet, hiragana, katakana, kanji, numbers, braille, etc.), figures (polygons, circles, etc.), and symbols (buttons for device operation, icons indicating device status, etc.,) can be raised.

The color of the design displayed in the display field 30 of the skin layer 3 may be a single color or multiple colors. The color may be expressed in the display field 30 by one or more selected from each layer and the light source part 8. The light transmittance property of each layer is not particularly limited. The light transmittance property may be colored transparent, translucent, etc. The color (hue, saturation, brightness) of each layer and the light source 80 is not particularly limited. The skin layer 3 does not have to have an uneven part such as the texture part 31. The surface of the skin layer 3 may be, for example, a smooth surface.

The brightness of the light source 80 is not particularly limited. The type, arrangement quantity, and position of the light source 80 are not particularly limited. The light source 80 may be an organic EL sheet, an inorganic EL sheet, a luminous sheet, etc. Also, the light source part 8 may include the light source 80 and a light guide plate (for example, an acrylic plate).

The type of interior member on which the decorative sheet 1 is arranged is not particularly limited. Examples may include the door trim 9, seat, armrest, floor, ceiling, instrument panel, glove box, steering wheel, center console, register, etc. The surface of the interior member (the surface of the skin layer 3) may be a flat surface or a curved surface. The orientation of the interior member (the orientation of the decorative sheet 1 in the outer-back direction) is not particularly limited. That is, the outer-back direction may be a vertical direction, a horizontal direction, or a direction intersecting the vertical direction and the horizontal direction. The decorative sheet 1 may be arranged on an interior member of a transportation machine other than vehicles (motorcycles, ships, aircraft, etc.), a building (houses, etc.), etc. Also, the decorative sheet 1 may be arranged on an exterior member (exterior walls of transportation machines, buildings, etc.)

### (Regarding Materials)

The material of the skin layer 3 is not particularly limited. Examples may include synthetic leather, resin, elastomer, nonwoven fabric, various fabrics (woven fabric, knitted fabric, etc.), etc. As the synthetic leather, examples may include resin, and elastomer, specifically, acrylic, polyethylene terephthalate, polycarbonate, polyvinyl chloride, silicone, epoxy, polyurethane, styrene-based thermoplastic elastomer, olefin-based thermoplastic elastomer, dynamically crosslinked thermoplastic elastomer, etc. As the nonwoven fabric and various fabrics, examples may include polyester, polypropylene, nylon, cotton, etc. The skin layer 3 may contain a colorant (colored polyethylene, etc.), a light diffusing agent (silicone, acrylic, titanium oxide, etc.), and a light absorbing agent (titanium black, carbon black, etc.)

The material of the intermediate layer 4 is not particularly limited. Examples may include resin, elastomer, etc., such as acrylic, polyethylene terephthalate, polycarbonate, polyvinyl chloride, silicone, polyester, epoxy, polyurethane, styrene-based thermoplastic elastomer, olefin-based thermoplastic elastomer, dynamically crosslinked thermoplastic elastomer, etc. The intermediate layer 4 may contain the colorant, light diffusing agent, and light absorbing agent.

The material of the design layer 5 is not particularly limited. Examples may include resin, elastomer, etc., such as acrylic, polyethylene terephthalate, polycarbonate, polyvinyl chloride, silicone, polyester, epoxy, polyurethane, styrene-based thermoplastic elastomer, olefin-based thermoplastic elastomer, dynamically crosslinked thermoplastic elastomer, etc. The design layer 5 may contain the colorant, light diffusing agent, and light absorbing agent.

The material of the flexible layer 6 is not particularly limited. Examples may include elastomer, such as styrene-based thermoplastic elastomer, olefin-based thermoplastic elastomer, dynamically crosslinked thermoplastic elastomer, etc., and foam such as polyurethane foam, etc.

The material of the base layer 7 is not particularly limited. Examples may include resin, elastomer, etc., such as acrylic, polyethylene terephthalate, polycarbonate, polyvinyl chloride, silicone, polyester, epoxy, polyurethane, styrene-based thermoplastic elastomer, olefin-based thermoplastic elastomer, dynamically crosslinked thermoplastic elastomer, etc.

When each layer is light-diffusive, the method for imparting the light diffusivity is not particularly limited. For example, a light diffusing agent (silicone, acrylic, titanium oxide, etc.,) having a refractive index different from that of the base material may be dispersed in a transparent base material.

The lamination method of each layer is not particularly limited. Screen printing (silk screen printing, etc.), gravure printing, inkjet printing, flexographic printing, etc., may be used. Also, each layer may be laminated by adhesion, pressure bonding, sticking, vapor deposition, welding, coating, etc. A film-shaped layer (for example, design layer 5) may be adhered to the back surface of an arbitrary layer (for example, intermediate layer 4). Also, a layer (for example, intermediate layer 4) may be coated on the back surface of an arbitrary layer (for example, skin layer 3).

What is claimed is:

1. A decorative sheet, comprising:
a skin layer, being light-transmissive;
an intermediate layer, arranged on a back side of the skin layer;
a design layer, arranged on a back side of the intermediate layer and having a design field on which a predetermined design is drawn,
wherein the skin layer has a display field on which the design is displayed by light irradiated from a back side to the design field, and
the design field is arranged gaplessly over an entire surface of the display field when viewed from an outer side, and has higher light transmittance than the intermediate layer.

2. The decorative sheet according to claim 1, wherein a visible light transmittance rate of the intermediate layer is 3% or more and 50% or less.

3. The decorative sheet according to claim 1, wherein a visible light transmittance rate of the design field is 5% or more and 90% or less.

4. The decorative sheet according to claim 1, wherein the decorative sheet is arranged on an interior member of a vehicle.

5. A manufacturing method of a decorative sheet, wherein the decorative sheet comprises:
a skin layer, being light-transmissive;
an intermediate layer, arranged on a back side of the skin layer;
a design layer, arranged on a back side of the intermediate layer and having a design field on which a predetermined design is drawn,
the skin layer has a display field on which the design is displayed by light irradiated from a back side to the design field,
the design field is arranged gaplessly over an entire surface of the display field when viewed from an outer side, and has higher light transmittance than the intermediate layer, and
the manufacturing method comprises:
an intermediate layer printing step of printing the intermediate layer on a back surface of the skin layer; and
a design layer printing step of printing the design layer on a back surface of the intermediate layer.
